(19) United States
(12) Patent Application Publication
(10) Pub. No.: US 2008/0133936 A1
(43) Pub. Date: Jun. 5, 2008

(54) Input display device, input display method, recording medium storing input display program, and electronic device

(75) Inventors: Yukiko Masuoka, Osaka-shi (JP); Chihiro Itoh, Osaka-shi (JP); Yoshinori Minakata, Osaka-shi (JP); Toshihiro Seko, Osaka-shi (JP); Yuzuru Naganuma, Osaka-shi (JP); Kenichi Katsura, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/904,384

(22) Filed: Sep. 27, 2007

(30) Foreign Application Priority Data
Sep. 29, 2006 (JP) 2006-268910

(51) Int. Cl. H04L 9/00; G06F 3/048

(52) U.S. Cl. 713/193; 715/764

(57) ABSTRACT

An input display device, including: a display area that displays a plurality of input keys; and a display controller that controls display of the plurality of input keys displayed in the display area. The display controller includes: a combination data creating portion that creates combination data of a first input key and a second input key which has been selected next to the first input key; a storage portion that stores the combination data in a memory; a candidate key extracting portion that extracts the second input key from the memory on the basis of the combination data stored in the memory when the first input key displayed on the display area is selected; and a display portion that allows the display area to display the second input key extracted by the candidate key extracting portion as a candidate which is to be selected next.

### BACKGROUND OF THE INVENTION

1. Field of the Invention

The present invention relates to an input display device, input display method, recording medium storing input display program, and electronic device in which a next input key is predicted in accordance with a selection of a specified input key, and the predicted key is displayed effectively.

2. Description of the Related Art

Conventionally, in an operation panel such as a touch panel mounted on an image forming apparatus and the like, input keys are arranged on sheets which are arranged hierarchically as shown in FIG. 11. A user can select a certain sheet (tab) and necessary input keys to allow the image forming apparatus to execute a desired processing. It should be noted that FIG. 11 shows a state where a primary sheet is automatically selected as an initial screen.

Here, the input keys are arranged such that keys associated with each other are arranged hierarchically in a program. When any input key is selected, input keys which are associated with the selected key are displayed. Therefore, a user needs to press down input keys in a step-by-step manner to terminate a setting of a desired processing.

Therefore, in some cases depending on a content of a desired processing, a user has to select input keys for many times to set one processing, and it has been burdensome for the user. In particular, when an input key which is frequently used by a user is located in a lower layer, it requires more effort and time, thereby making it hard to use.

In view of solving such problem described above, there has been proposed a touch panel device in which a layout can be changed automatically so as to allow, for example, frequently used keys to be displayed at predetermined positions. In the conventionally proposed touch panel device as described above, the frequently used keys are displayed as direct keys on a touch panel. However, in many cases, primary keys and the like which are most frequently used are initially displayed on a touch panel (refer to FIG. 11).

Therefore, when a layout is changed so as to allow the frequently used keys to be displayed on the touch panel, the same keys are displayed on the touch panel redundantly in many cases. Such redundant display of the keys causes not only inefficiency but also a likelihood to puzzle a user.

Further, the direct keys as described above are of mere arranged function keys which are used frequently, and do not have relations to each other. Accordingly, depending on a user's frequency and tendency of use of the keys, it may become more hard to use.

### SUMMARY OF INVENTION

An input display device according to one aspect of the present invention comprises: a display area that displays a plurality of input keys; and a display controller that controls display of the plurality of input keys displayed in the display area. The display controller includes: a combination data creating portion that creates combination data of a first input key selected among the plurality of input keys and a second input key which has been selected next to the first input key; a storage portion that stores the combination data created by the combination data creating portion in a recording medium; a candidate key extracting portion that extracts the second input key which has been selected next to the first input key from the recording medium on the basis of the combination data stored in the recording medium when the first input key displayed on the display area is selected; and a display portion that allows the display area to display the second input key extracted by the candidate key extracting portion as a candidate which is to be selected next.

The above-described input display device allows the display area portion to display a second input key which has been selected next to the first input key as a candidate key which is to be selected next when the first input key is selected.

These and other objects, features and advantages of the present invention will become more apparent upon reading of the following detailed description along with the accompanied drawings.

### BRIEF DESCRIPTION OF DRAWINGS

FIG. 1 schematically shows a screen display of an input display device according to an embodiment of the present invention.

FIG. 2 is a block diagram showing a schematic configuration of an image forming apparatus provided with the input display device according to the embodiment of the present invention.

FIG. 3 is a flowchart showing operation steps of the input display device provided in the image forming apparatus according to the embodiment of the present invention.

FIG. 4 is a first screen display as a reference for describing transitions of the screen of the input display device provided in the image forming apparatus according to the embodiment of the present invention.

FIG. 5 is a second screen display as a reference for describing transitions of the screen of the input display device provided in the image forming apparatus according to the embodiment of the present invention.

FIG. 6 is a third screen display as a reference for describing transitions of the screen of the input display device provided in the image forming apparatus according to the embodiment of the present invention.

FIG. 7 is a fourth screen display as a reference for describing transitions of the screen of the input display device provided in the image forming apparatus according to the embodiment of the present invention.

FIG. 8 is a flowchart showing steps of statistical processing of the input display device according to the embodiment of the present invention.

FIG. 9 is a flowchart showing steps of display processing of the input display device according to the embodiment of the present invention.

FIG. 10 is a table showing combination data which are sorted by predetermined sorting means and stored in a storage table in the input display device according to the embodiment of the present invention.

FIG. 11 is a screen display as a reference for describing a conventional input display device.

### DETAILED DESCRIPTION OF THE PREFERRED EMBODIMENTS

Hereinafter, an embodiment of the present invention will be described with reference to the drawings. It should be noted that the same parts are identified with the same reference numeral, and descriptions of the parts identified with the same reference numeral in the drawings are omitted in some cases.

An image forming apparatus (electronic device) provided with a touch panel (input display device) according to the present embodiment is realized by processing, means, and functions executed by a computer in accordance with orders given by a program (software). A program transmits instructions to components of a computer to allow them to perform predetermined processing and function as described herebelow. In other words, the processing and means of the touch panel (input display device) according to the present embodiment is realized by specific means of a program and computer cooperating with each other.

A whole or part of the program is provided through any computer-readable recording medium such as a magnetic disk, an optical disk, and a semiconductor memory. The program read out from the recording medium is installed to a computer for execution. Further, the program can be loaded directly through a communication line and executed without a recording medium.

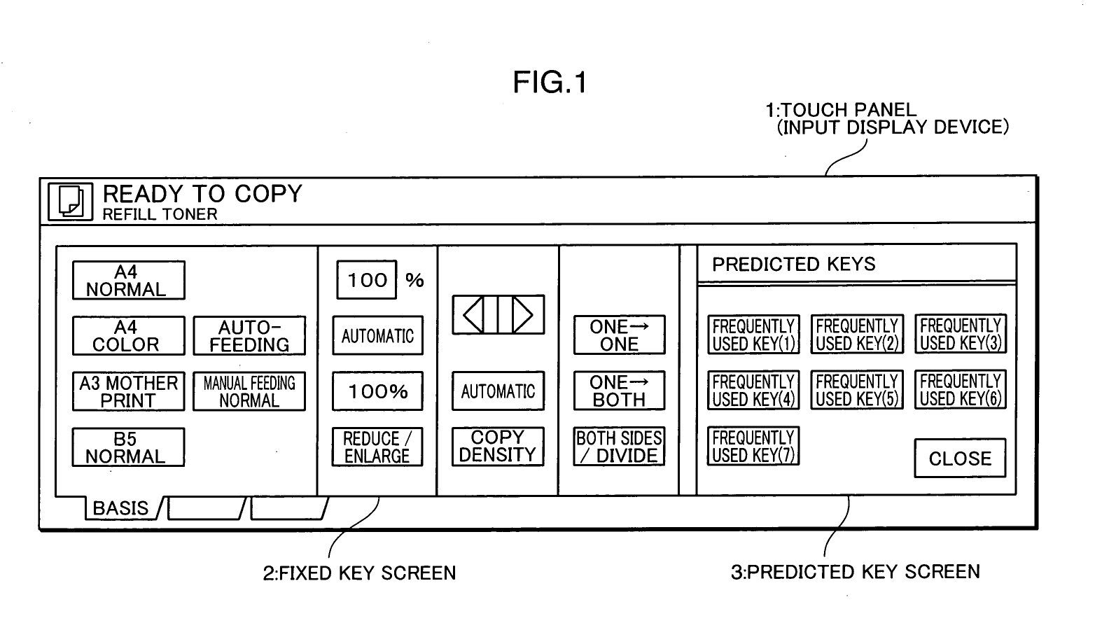

FIG. 1 schematically shows a screen display of a touch panel (input display device) provided in an image forming apparatus according to an embodiment of the present invention.

As shown in FIG. 1, a touch panel 1 according to the present embodiment is provided with a display screen including a fixed key screen 2 and a predicted key screen 3. The fixed key screen 2 and the predicted key screen 3 are so configured to be independent from each other.

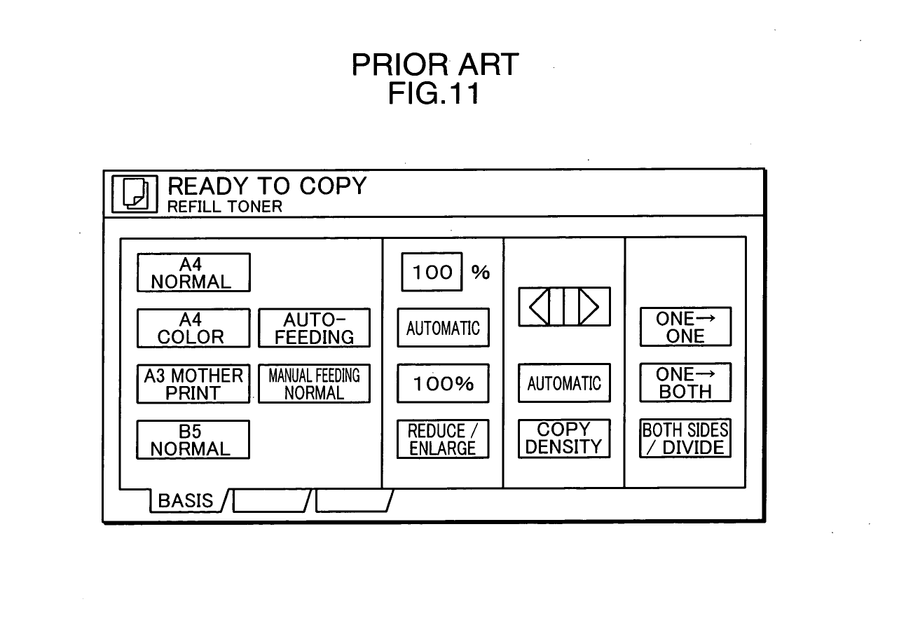

The fixed key screen 2 has substantially the same key alignment as that of a conventional touch panel shown in FIG. 11, and its display area (first display area) has primary keys and the like which are fixedly aligned.

The touch panel 1 is mounted to an image forming apparatus such as a printer to serve as an input device.

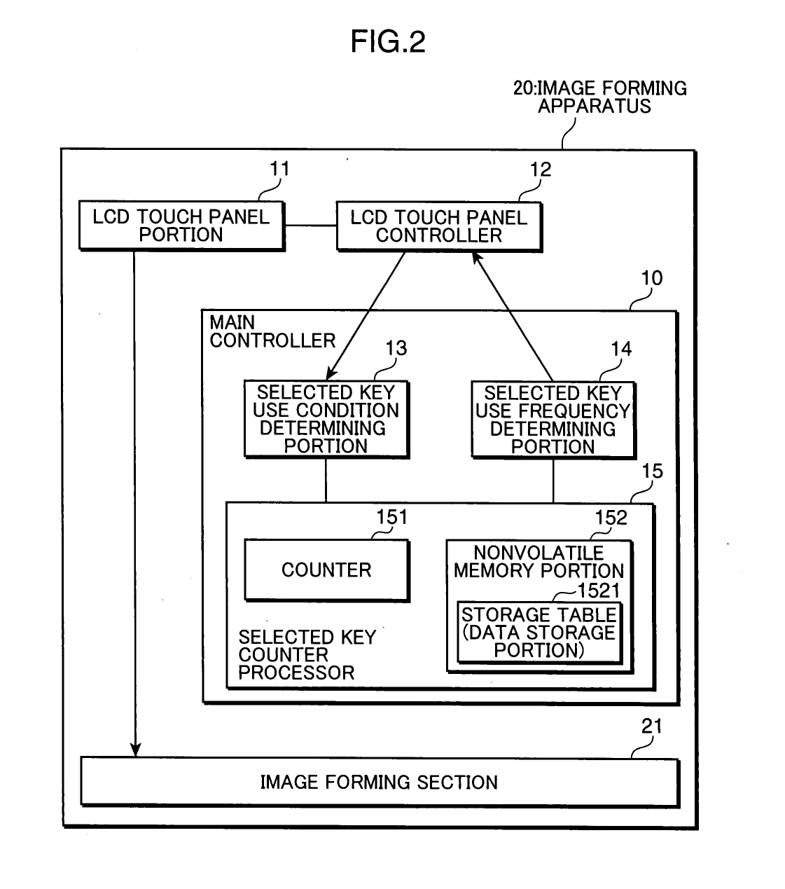

In other words, an image forming apparatus will be described as an electronic device provided with an input device according to the present embodiment (refer to FIG. 2 described hereinafter).

Thus, components which execute image forming processing in accordance with an input processing operated through an input device (touch panel 1) in the image forming apparatus, more particularly, an image forming section, a printing processing section, a sheet conveying device, a controller and the like correspond to processing executing devices which execute predetermined processing of the electronic device according to the embodiment.

The predicted key screen 3 includes a display area (second display area) where input keys, which are likely to be selected next in accordance with selection of any input key, are aligned.

As described above, predicted keys are newly displayed while input keys are displayed in such a manner similar to the conventional manner. Accordingly, a user can make operation in a conventional manner while performing a user-friendly operation.

In the predicted key screen 3 shown in FIG. 1, candidate input keys of seven functions having higher use frequencies are aligned in descending order from upper left of the predicted key screen 3.

FIG. 2 is a block diagram showing a schematic configuration of an image forming apparatus 20 provided with the touch panel 1 according to the present embodiment.

As shown in FIG. 2, the image forming apparatus 20 provided with the touch panel 1 according to the present embodiment includes a main controller 10, an LCD touch panel section 11, an LCD touch panel controller 12, and an image forming section 21.

The LCD touch panel section 11 is composed of an LCD (Liquid Crystal Display). The LCD touch panel section 11 is a display device adapted to perform the display of input keys and the like which are necessary for operation, and it is also an input interface adapted to allow a user to perform input operation through the LCD.

An input operation performed through the LCD touch panel section 11 allows a predetermined image forming processing to be executed in the image forming section 21.

The LCD touch panel controller 12 is adapted to perform an intermediate processing between the main controller 10 and the LCD touch panel section 11, and outputs input key selection information among information inputted through the LCD touch panel section 11 to a selected key use condition determining portion 13.

The main controller 10 includes a selected key use condition determining portion 13, a selected key use frequency determining portion 14, and a selected key counter processor 15.

The selected key use condition determining portion 13 is adapted to obtain information regarding an input key used by a user through the LCD touch panel controller 12 to determine which key is selected.

Especially, in the present embodiment, the selected key use condition determining portion 13 has a role of identifying a first input key selected by a user in the past and a second input key selected next to create combination data of these input keys (combination data creating means).

The selected key use frequency determining portion 14 is adapted to sort (sorting means) the combination data in the order of use frequency on the basis of the number of times of selection counted by the selected key counter processor 15.

Specifically, the selected key use frequency determining portion 14 extracts (candidate key extracting means) input keys (second input keys) of combination data whose use frequency are in relatively higher ranks among combinations of input keys selected consecutively, and allows the LCD touch panel section 11 to display (display means) the extracted input keys through the touch panel controller 12.

The number of keys extracted as input keys having high use frequency can be a certain number on the basis of their respective use frequencies, and the extracted keys are sorted in ranks of their use frequencies, outputted and displayed. It is preferable that the number of extracted candidate keys is set to be an appropriate number in accordance with a size of a display area of the LCD touch panel section 11, viewability of display, easiness for a user to determine the selection, and the like.

In the present embodiment, as will be described hereinafter, seven candidate keys are displayed at maximum. When there are less than seven candidate keys, all of relevant candidate keys are displayed. Further, the number of candidate keys which are displayed can be set or changed to be any desirable number by a user.

The selected key counter processor 15 includes a counter 151 and a nonvolatile memory portion 152. The counter 151 is adapted to count the number of selections of a combination of a selected input key and another input key selected next. The nonvolatile memory portion 152 stores the result in predetermined storage means.

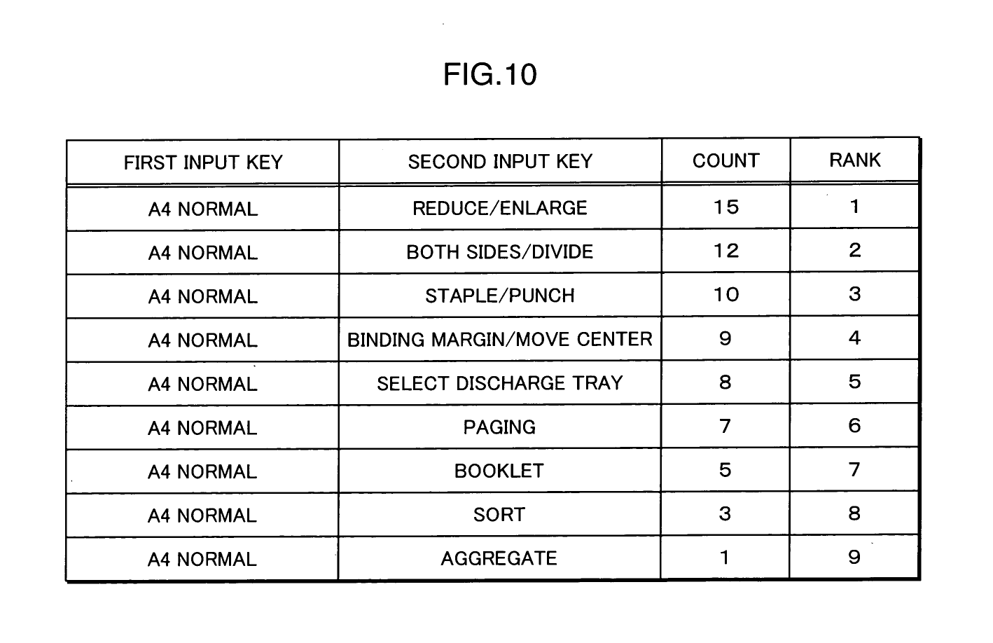

As a specific storage means in the nonvolatile memory portion 152, the nonvolatile memory portion 152 associates the combination data and the number of selection and stores the combination data in a predetermined storage table (data storage portion) 1521 in the ranks of respective use frequencies of the combination data (refer to FIG. 10).

The image forming section 21 is a processing executing means for executing a predetermined image forming processing in accordance with input signals transmitted from the LCD touch panel section 11. The image forming section 21 has a configuration which is similar to an existing image forming apparatus, and includes components such as an image forming section, a printing section, a sheet conveying device, a controller and the like for executing image forming processing on the basis of an input processing from the LCD touch panel section 11.

In particular, the image forming section 21 includes an input buffer for receiving input data to be printed out, a CPU for controlling an overall operation of the apparatus, a program ROM storing a program describing operation of the CPU, a data RAM storing image data and calculation data taken out from control codes, a print image transfer portion for converting image data converted for output into data of a final step and transferring the data to a printer engine, the printer engine for printing a print image to a predetermined printing sheet, a sheet conveying section for conveying a printing sheet to the printer engine, and the like.

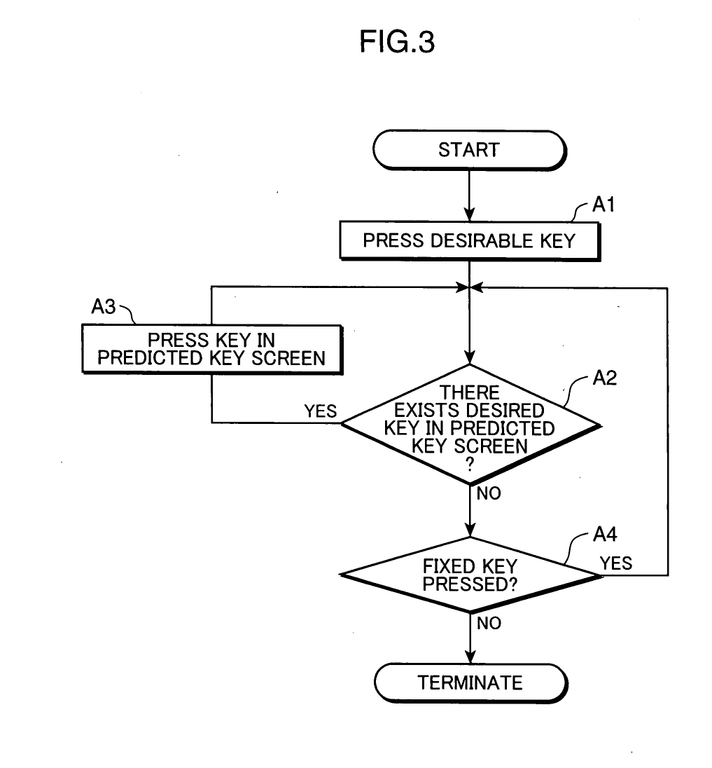

Next, operation steps of a touch panel (input display device) provided in the image forming apparatus 20 according to the present embodiment having the above-described configuration will be described with reference to FIGS. 3 to 7.

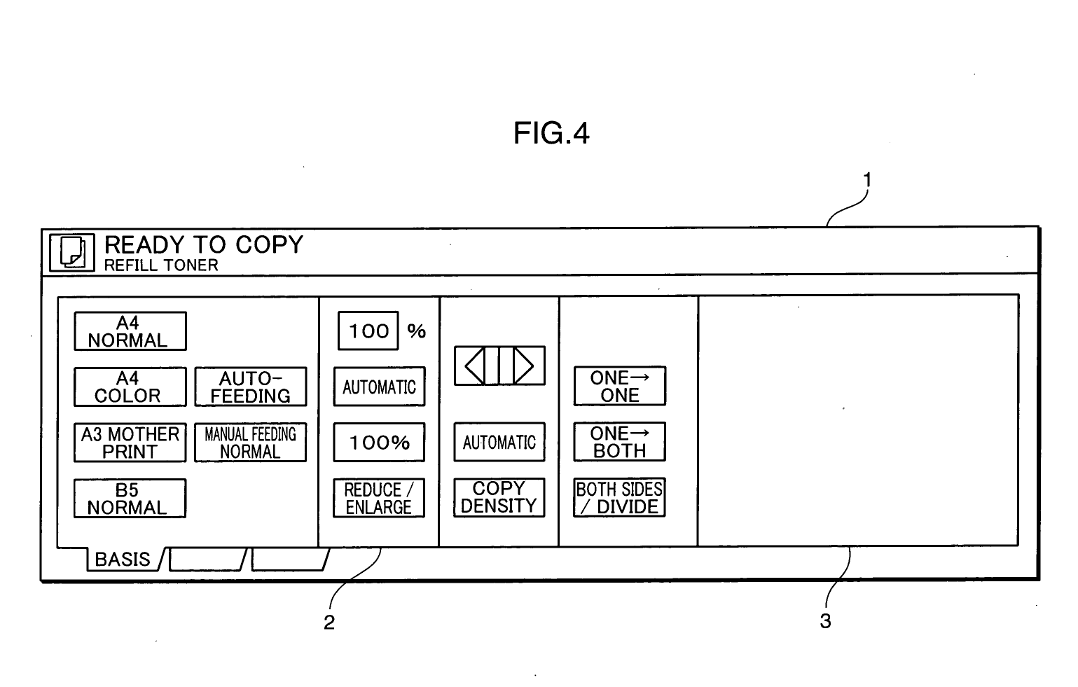

FIG. 3 is a flowchart showing operation steps of the touch panel according to the present embodiment. FIGS. 4 to 7 show screen displays as references for describing screen transitions which occurs when a predetermined input key is selected.

As shown in FIG. 3, any one of input keys of the LCD touch panel section 11 on the touch panel 1 is pressed firstly by a user (A1). In an initial state where none of the input keys is pressed by a user yet, any desirable key among the input keys aligned in the fixed key screen 2 is to be selected by a user (refer to FIG. 4).

Next, if there exists a key which is a subject of the user selection on the predicted key screen 3 (A2:YES), a user presses the key (A3). The pressing operation of A3 is continued until a next key which is the subject of the user selection does not appear on the predicted key screen 3.

On the other hand, if there exists no key subjected to the user selection on the predicted key screen 3 (A2:NO), it is determined whether or not there exists a key subjected to the user selection on the fixed key screen 2 (A4).

If there exists no key which is the subject of the user selection on the fixed key screen 2 in step A4 (A4:NO), it is determined that selection of a key by the user is terminated or operation is aborted, and then the processing is terminated.

On the other hand, when there exists a key which is the subject of the user selection on the fixed key screen 2 in the step A4, and the user presses down the input key (A4:YES), candidate keys associated with the pressed key are displayed on the predicted key screen 3. Then, the routine goes back to the step A2, and then a predetermined processing is executed again.

It is effective when the user would like to start over again on performing another operation from the first. Accordingly, the user can start another operation immediately without tracing back the previous processing.

In the above, the steps of user's operation are schematically described above with reference to the flowchart. Next, an operative example of the operation steps will be described in detail with reference to FIGS. 4 to 7.

In the example of the operation steps, a case of forming an image of a document which is enlarged by 141% and outputting the same to an A4 normal paper sheet will be described.

First, in an initial state, the touch panel 1 is not operated by a user. Thus, it is in a state where no input key is selected. In such state, an initial screen of the touch panel 1 displays only input keys constituting the fixed key screen 2 as shown in FIG. 4, and nothing is displayed on the predicted key screen 3.

From this state, the user selects and presses an “A4 NORMAL” key of the LCD touch panel section 11 of the touch panel firstly to allow the image forming section to perform a certain processing.

When the LCD touch panel section 11 is operated, the LCD touch panel controller 12 outputs operation signals to the main controller 10. The selected key use condition determining portion 13 detects on the basis of the operation signals that the “A4 NORMAL” key of the LCD touch panel section 11 is pressed by a user.

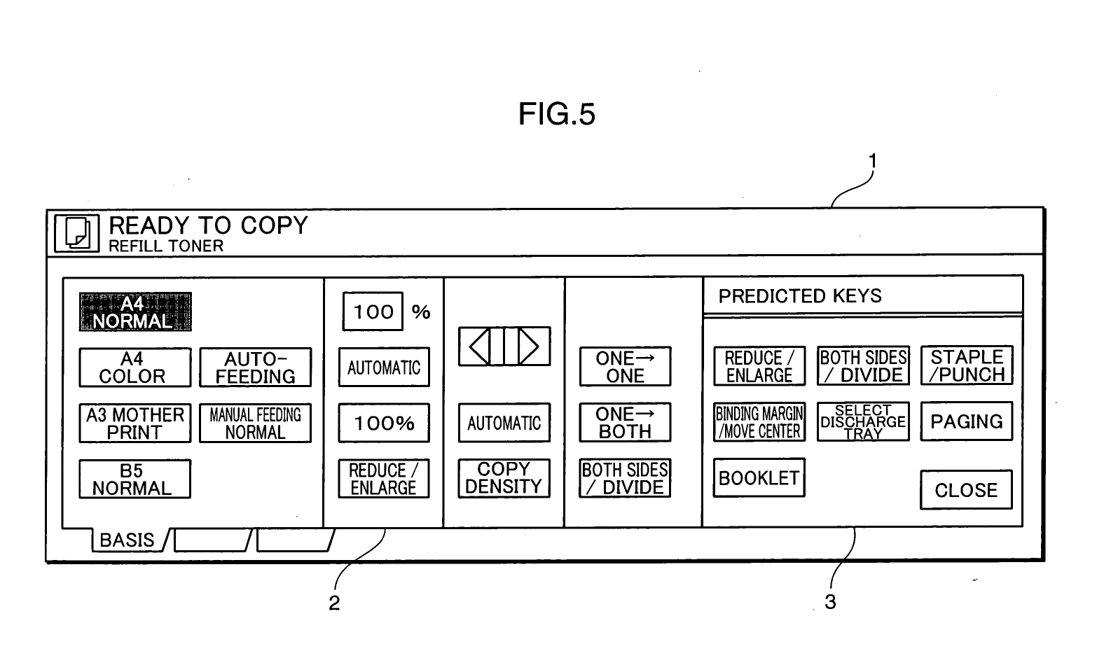

When the selected key use condition determining portion 13 detects the pressing “A4 NORMAL” key, the selected key use frequency determining portion 14 reads out information of frequently used operation keys which are associated with the “A4 NORMAL” key from the storage table (data storage portion) 1521 of the selected key counter processor 15. Then, as shown in FIG. 5, seven keys are displayed on the predicted key screen 3 of the LCD touch panel section 11 as “predicted keys.”

It should be noted that the number of the predicted key displayed on the predicted key screen 3 may be set desirably in advance, and the user can set and change a desirable display number.

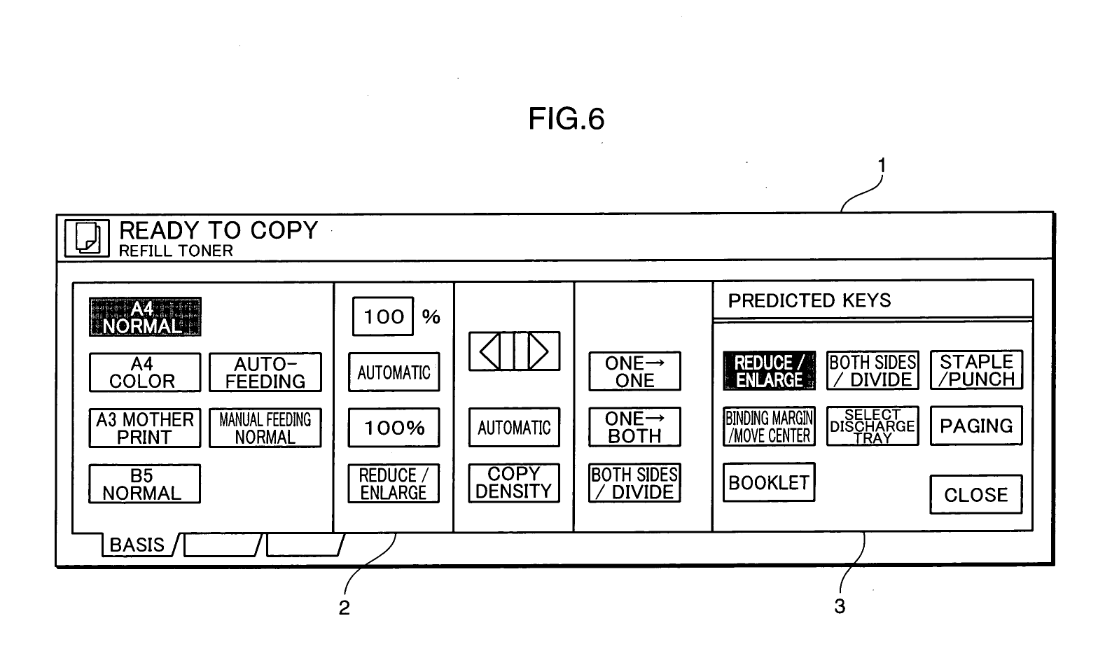

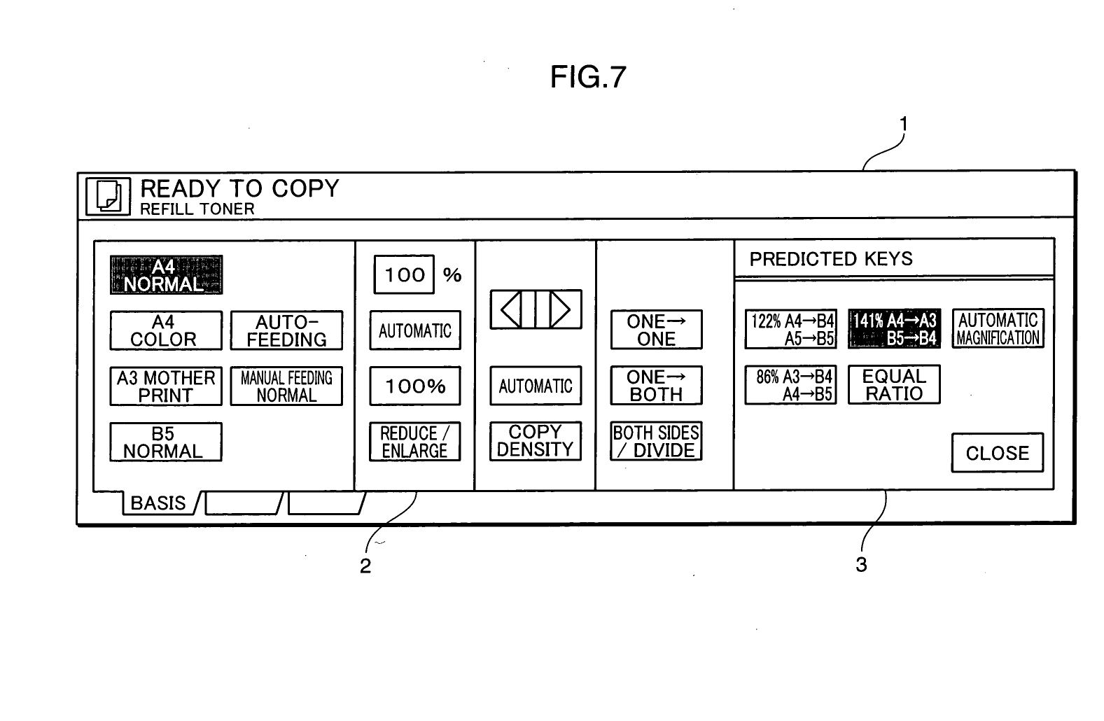

Next, when the user presses a “REDUCE/ENLARGE” key on the predicted key screen 3 of the LCD touch panel section 11 as shown in FIG. 6, the selected key use condition determining portion 13 detects that the “REDUCE/ENLARGE” key on the predicted key screen 3 is pressed, and the selected key use frequency determining portion 14 reads out information of frequently used operation keys which are associated with the “REDUCE/ENLARGE” key and from the storage table (data storage portion) 1521. Then, as shown in FIG. 7, five keys are displayed on the predicted key screen 3 as “predicted keys.”

Here, five keys are displayed as predicted keys. As described above, the maximum number of predicted keys which can be displayed on the predicted key screen 3 is set to be seven. However, when the number of predicted input keys is less than seven, only relevant input keys are displayed.

In particular, as shown in FIG. 7, input keys respectively presenting specific magnifications are displayed on the predicted key screen 3 as frequently used keys associated with the “REDUCE/ENLARGE” key in the order of their respective frequency of use.

When the user presses a desired key e.g. “141%” key in such state, an operation signal is inputted to the image forming section 21, and then a predetermined image forming processing is performed. In other words, a processing of printing an image at a magnification of 141% is performed in this case.

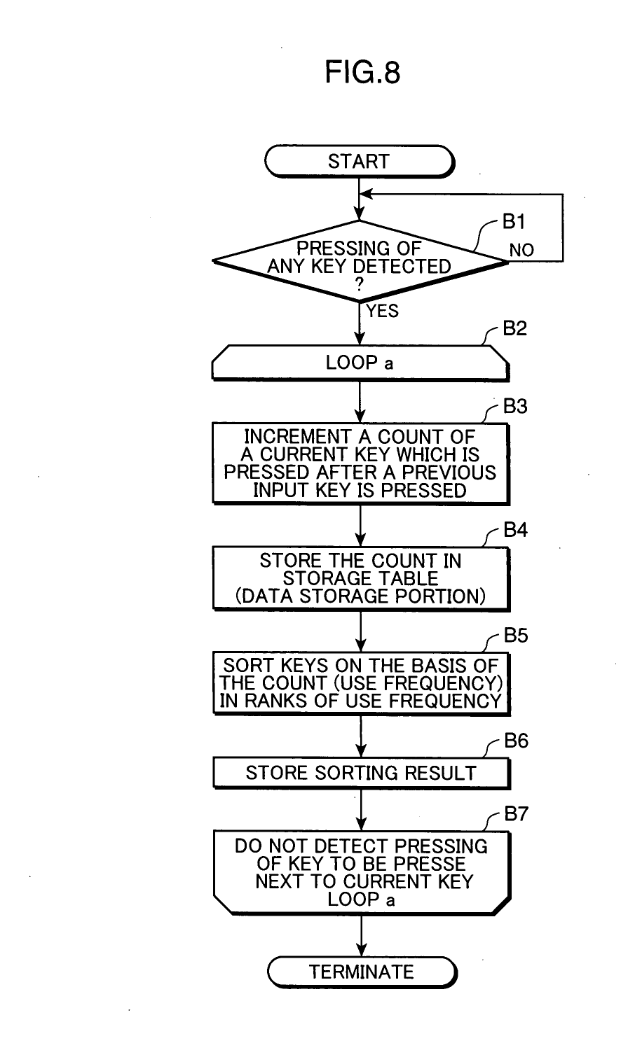

Next, a statistical processing of the touch panel 1 (input display device) according to the present embodiment will be described with reference to FIG. 8.

FIG. 8 is a flowchart showing steps of the statistical processing of the touch panel 1 according to the embodiment of the present invention.

First, in the touch panel 1 according to the present embodiment, the selected key use frequency determining portion 14 tries detection of an input key which is pressed (B1). When an input key which is pressed is detected (B1:YES), processing of a loop “a” including steps B2 to B7 is executed.

When an input key which is pressed is not detected (B1:NO), the selected key use frequency determining portion 14 keeps monitoring until it detects the input key which is pressed.

Here, in particular, the processing of the steps B3 to B6 are repeated in the processing of the loop “a”. However, as presented in the step B7, the loop processing is not executed and will be terminated if a next input key which is pressed is not detected. In other words, as long as next input key is pressed, the processing of the loop “a” is performed repeatedly.

In the loop “a”, at first, a count of a current key is incremented which is pressed after a previous input key is pressed (B3).

For example, in the above-described example, the current key (second input key) corresponds to the “REDUCE/ENLARGE” key, and the previous input key (first input key) corresponds to the “A4 NORMAL” key which is pressed directly before the current key. A count is incremented respectively for combinations of those.

Then, the incremented count is associated with combination data of the first input key and the second input key and temporarily stored in the nonvolatile memory portion 152 (B4).

Next, the combination data stored in the nonvolatile memory portion 152 are sorted in the ranks of use frequency on the basis of their respective count numbers (B5).

Then, as shown in FIG. 10, the data sorted in the step B5 are stored in the storage table (data storage portion) 1521 of the nonvolatile memory portion 152 (B6).

Thereafter, the series of statistical processing is terminated when the pressing of input keys by the user is terminated.

As described above, repetition of the processing B3 to B6 raises accuracy in the prediction processing described herebelow.

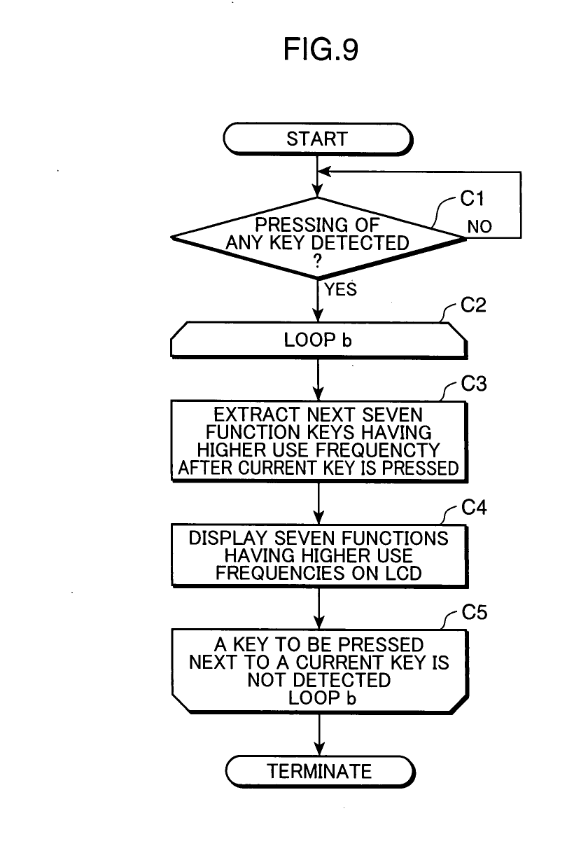

Next, a display processing in the touch panel 1 (input display device) according to the present embodiment will be described with reference to FIG. 9. FIG. 9 is a flowchart showing steps of the display processing in the touch panel 1 according to the embodiment of the present invention.

First, in the touch panel 1 according to the present embodiment, the selected key use frequency determining portion 14 tries detection of an input key which is pressed (C1). When an input key which is pressed is detected (C1:YES), a processing of a loop “b” including steps C2 to C5 is executed.

When an input key which is pressed is not detected (C1:NO), the selected key use frequency determining portion 14 continues monitoring until it detects the input key.

Here, in particular, the processing of the steps C2 to C5 are repeated in the processing of the loop “b”. However, as presented in the step C5, the loop processing is not executed if it is not detected that next input key is pressed. In other words, as long as next input key is pressed, the processing of the loop “b” is performed repeatedly.

In the loop “b”, firstly, second input keys are extracted which are frequently used among data sorted in the above-described statistical processing (refer to FIG. 10) (C3). In the present embodiment, top seven function keys are extracted as shown in FIG. 1.

Then, the second input keys are displayed on the predicted key screen 3 of the LCD in the descending order on the basis of their respective use frequencies (refer to FIG. 5).

As described above, according to the touch panel (input display device) 1 of the present embodiment, the combination data which are frequently selected are extracted in rank by counting the numbers of respective selected times of the combinations of consecutively selected input keys are counted and obtaining statistic data. Accordingly, candidate input keys are predicted effectively.

By displaying a screen for predicted input keys (predicted key screen 3) along with the fixed key screen 2 on which primary keys and the like are displayed as described above, further improvement in operability can be accomplished while conventional operation steps are inherited.

Further, according to the touch panel 1 of the present embodiment, the similar effect can be accomplished not only by applying the same to an image forming apparatus but also by mounting or connecting to other electronic devices.

In other words, any kind of equipment or device can provide an advanced operability and convenience by mounting the touch panel (input display device) 1 of the present invention as an input device as long as the equipment or device is an electronic device provided with an input device for execution of a predetermined processing and a processing executing device for executing the predetermined processing.

Further, according to the above, the present invention can be smoothly incorporated to an electronic device provided with a conventional input device so that the input display device 1 which is advanced not only in operability but also in versatility can be provided.

In the above, the input display device according to the present invention is described along with a preferred embodiment. However, it goes without saying that the input display device according to the present invention is not limited to the above-described embodiment and may be changed in various ways within the scope of the present invention.

For example, the input display device according to the invention is not limited to the one adopting a touch panel type. The input device may have any type of configuration as long as alignment of displayed key can be desirably changed.

Specifically, the input display device may have a configuration of an operation panel which is started up and displayed in a personal computer. In this case, a desirable processing is executed when a user operates a mouse and the like to click on a screen.

Further, in the above-described embodiment, the input display device has a configuration of being uniformly provided in an electronic device such as an image forming apparatus. However, it may be surely configured as to be separable from an electronic device. For example, the input display device according to the present embodiment may be so configured as to be a remote-control type input terminal which is communicably connected to an apparatus main body in a wired or wireless manner.

The present invention may be used favorably in an image forming apparatus such as a printer, a copying machine, and a complex machine provided with an input display device such as a touch panel, or in other apparatus or electronic device.

According to the present invention, a desirable input key is predicted with predetermined means and displayed effectively so that an input operation can be smoothly performed by a user. Consequently, an input display device advanced in convenience and operability can be provided.

According to the above-described embodiments, the present invention will be summarized as follows. Specifically, an input display device according to one aspect of the present invention comprises: a display area that displays a plurality of input keys; and a display controller that controls display of the plurality of input keys displayed in the display area. The display controller includes: a combination data creating portion that creates combination data of a first input key and a second input key which has been selected next to the first input key, the first and second input keys selected among the plurality of input keys; a storage portion that stores the combination data created by the combination data creating portion in a memory; a candidate key extracting portion that extracts the second input key which has been selected next to the first input key from the recording medium on the basis of the combination data stored in the memory when the first input key displayed on the display area is selected; and a display portion that allows the display area to display the second input key extracted by the candidate key extracting portion as a candidate which is to be selected next.

According to the above-described input display device, when the first input key is selected, a second input key which has been selected next to the first input key is displayed on the display area as a candidate which is to be selected next. Therefore, when a user of the above-described input display device selects a first input key, second input keys which are candidate to be selected next can be displayed. Accordingly, the user can select a display second input key which is to be selected next effectively. This allows the user to effectively select a second input key which should be selected next. In other words, the user can identify a desirable input key quickly and operate efficiently so that an input display causing less burden on the user and advanced in convenience can be realized.

Here, in the above-described input display device, past selection patterns of the user is analyzed, and an input key which is to be selected by the user is extracted and displayed. Then, the second input keys associated with the first input key are extracted and displayed as predicted candidate input keys. Therefore, candidate input keys are predicted effectively not only on the basis of mere use frequency of an input key alone, but also analysis in view of previous and next selection of input keys.

As described above, the user can quickly identify a desirable input key and can make operations efficiently. Accordingly, an input display device causing less burden on the user and advanced in convenience can be realized.

It is preferable that the input display device further comprises: a counter that counts the number of selections of each of a plurality of combination data created by the combination data creating portion; and a sorting portion that sorts the plurality of combination data counted by the counter into groups having the same first input key in accordance with their respective number of selections, and the display controller further includes the counter and the sorting portion, and the candidate key extracting portion extracts from the memory the second input key included in combination data which is within a range of predetermined ranks among the combination data sorted by the sorting portion.

In this case, the number of selections of each of a plurality of combination data is counted, and the plurality of combination data having the same first input key is sorted in accordance with their respective number of selections so that a second input key included in combination data which is within a range of predetermined ranks can be displayed as a candidate to be selected next. Accordingly, a user can select a second input key which should be selected next efficiently.

Here, the number of selections of each of a plurality of combinations of a first input key and a second input key is counted, and statistic data of use frequency is made. Accordingly, an input display device which can provide enhanced operability in accordance with a use frequency by the user, a use characteristic and the like is realized.

It is preferable that the display portion allows the display area to display at least one second input key extracted by the candidate key extracting portion in accordance with the rank of combination data sorted by the sorting portion.

In this case, second input keys to be selected next are displayed in the display in accordance with the rank of selections of combination data. Accordingly, a user can efficiently select a second input key to be selected next.

Here, for example, a plurality of input keys predicted as candidates may be displayed in accordance with the rank of selections in descending order. In other words, according to the past statistic data, it may be arranged so that an input key having a higher selection number comes to a higher rank. Accordingly, it becomes likely that a user finds a desirable next key easily, and an operability and convenience can be further improved.

It is preferable that the sorting portion sorts the plurality of combination data so that combination data having a large selection number comes to a higher rank, and the display portion allows the display area to display the second input key included in the combination data sorted at the higher rank among the plurality of combination data sorted by the sorting portion as a higher-rank candidate.

In this case, a second input key of a combination having a large selection number is extracted, and is displayed as a second input key having the selection number which comes to a higher rank. In other words, the second input keys are displayed in a descending order in accordance with the selection number of input keys selected next according to past statistic data. Accordingly, a user is likely to find a desirable next key easily, and an operability and convenience can be further improved.

An electronic device according to another aspect of the present invention comprises: the above-described input display device; and a processing execution device that executes a predetermined processing in accordance with a selection of the plurality of input keys of the input display device.

In the above-described electronic device, when the first input key is selected, a second input key which has been selected next to the first input key can be displayed in the display area as a candidate to be selected next. Therefore, when a user of the above-described input display device selects a first input key, a second input key of a candidate to be selected next can be presented to the user. Accordingly, a second input key to be selected next can be selected by the user efficiently. Consequently, an operation of allowing a processing execution device to execute a certain processing is performed efficiently. For example, in an image forming apparatus provided with a touch panel as an input device, instructions regarding various processings of image forming such as an image forming processing, printing processing, sheet conveying processing and the like can be given through a selection of the input key of the touch panel to allow the respective parts to execute the processings. Therefore, the invention can be applied to various electronic devices requiring an input device to provide them technical effects of versatility and expandability.

An image forming apparatus according to another aspect of the present invention comprises: the above-described input display device; and an image forming section that executes a predetermined image forming processing in accordance with a selection of the plurality of input keys of the input display device. The display area is a touch panel including: a fixed key display area that displays a first input key on a steady basis; and a predicted key display area that selectively displays a second input key, the display portion allows the predicted key display area to display the second input key extracted by the candidate key extracting portion in accordance with a selection of the first input key when the first input key displayed on the fixed key display area is selected, and the image forming section executes an image forming processing which is determined on the basis of a combination of the selected first and second input keys.

In the above-described image forming apparatus, the second input keys extracted as candidates are displayed together with the first input keys on the display area. Further, in the display area, primary keys and the like which are generally used frequently are fixedly displayed as first input keys, and second input keys which are predicted as candidates are selectively displayed. Therefore, when a user would like to perform the operation over again, such as when the user made a mistake on operation, the user can quickly restart the processing by selecting the first input key. Further, by allowing the first input keys in accordance with an arrangement of keys similar to that having been used, conventional operation procedures can be inherited.

It is preferable that the first input key is associated with a specified one of a plurality of sheets fed to the image forming apparatus, and the second input key is associated with a specified one of a plurality of processings applied to a sheet fed to the image forming apparatus.

An input display method according to another aspect of the present invention comprising the steps of: (a) creating combination data of a first input key and a second input key which has been selected next to the first input key, the first and second input keys selected among a plurality of input keys; (b) storing the combination data created in step (a) in a memory; (c) extracting the second input key which has been selected next to the first input key from the memory on the basis of the combination data stored in the recording medium when the first input key displayed on the display area is selected; and (d) allowing the display area to display the second input key extracted in step (c) as a candidate which is to be selected next.

In the above-described input display method, when a first input key is selected, a second input key which has been selected next to the first input key can be displayed as a candidate to be selected next. Therefore, when the selects the first input key, a second input key to be selected next can be presented to a user. Accordingly, the user can efficiently select a second input key to be selected next.

It is preferable that the input display method further comprises: (e) counting the number of selections of each of a plurality of combination data created in step (a); and (f) sorting the plurality of combination data counted in step (e) into groups having the same first input key in accordance with their respective number of selections. Step (c) includes a step of extracting from the memory the second input key included in combination data which is within a range of predetermined ranks among the combination data sorted in step (f).

In this case, the number of selections of each of a plurality of combination data is counted, and the plurality of combination data are sorted into groups having the same first input key in accordance with their respective number of selections. A second key included in combination data which is within a range of predetermined ranks can be displayed as a candidate to be selected next. Accordingly, a user can efficiently select a second input key to be selected next.

It is preferable that step (d) includes a step of allowing the display area to display at least one second input key extracted in step (c) in accordance with the rank of combination data sorted in step (f).

In this case, second input keys to be selected next are displayed in the display area in accordance with the rank of selections of combination data. Accordingly, a user can efficiently select a second input key to be selected next.

It is preferable that step (f) includes a step of sorting the plurality of combination data so that combination data having a larger selection number comes to a higher rank, and step (d) includes a step of displaying the second input key included in combination data sorted at the higher rank among the plurality of combination data sorted in step (f) as a higher-rank candidate.

In this case, a second input key of a combination having a large selection number is extracted, and is displayed as a second input key having the selection number which comes to a higher rank. In other words, the second input keys are displayed in a descending order in accordance with the selection number of input keys selected next according to past statistic data. Accordingly, a user is likely to find a desirable next key easily, and an operability and convenience can be further improved.

A recording medium according to another aspect of the present invention stores an input display program which allows a computer to serve as an input display device, the program allows the computer to serve as: a combination data creating portion that creates combination data of a first input key and a second input key which has been selected next to the first input key, the first and second input keys selected among a plurality of input keys; a storage portion that stores the combination data created by the combination data creating portion in a memory; a candidate key extracting portion that extracts the second input key which has been selected next to the first input key from the memory on the basis of the combination data stored in the memory when the first input key displayed on the display area is selected; and a display portion that allows the display area to display the second input key extracted by the candidate key extracting portion as a candidate which is to be selected next.

According to the recording medium storing the above-described input display program, when the input display program is executed by the computer, and a first input key is selected, a second input key which has been selected next to the first input key is displayed as a candidate to be selected next. Therefore, when a user selects a first input key, second input keys which are candidates to be selected next are presented to the user. Accordingly, the user can select a second input key to be selected next efficiently.

It is not realized only with an input display device, but it may also be realized with other equipments requiring input display means by installing the program thereto so that an input display program having enhanced versatility and expandability can be provided.

It is preferable that the program allows the computer to further serve as: a counter that counts the number of selections of each of a plurality of combination data created by the combination data creating portion; and a sorting portion that sorts the plurality of combination data counted by the counter into groups having the same first input key in accordance with their respective number of selections. The candidate key extracting portion extracts from the memory the second input key included in combination data which is within a range of predetermined ranks among the combination data sorted by the sorting portion.

In this case, the number of selections of each of a plurality of combination data is counted, and the plurality of combination data having the same first input key is sorted in accordance with their respective number of selections so that a second input key included in combination data which is within a range of predetermined ranks can be displayed as a candidate to be selected next. Accordingly, a user can select a second input key which should be selected next efficiently.

It is preferable that the display portion allows the display area to display at least one second input key extracted by the candidate key extracting portion in accordance with the rank of combination data sorted by the sorting portion.

In this case, second input keys to be selected next are displayed in the display area in accordance with the rank of selections of combination data. Accordingly, a user can efficiently select a second input key to be selected next.

It is preferable that the sorting portion sorts the plurality of combination data so that combination data having a large selection number comes to a higher rank, and the display portion allows the display area to display the second input key included in the combination data sorted at the higher rank among the plurality of combination data stored by the sorting portion as a higher-rank candidate.

In this case, a second input key of a combination having a large selection number is extracted, and is displayed as a second input key having the selection number which comes to a higher rank. In other words, the second input keys are displayed in a descending order in accordance with the selection number of input keys selected next according to past statistic data. Accordingly, a user is likely to find a desirable next key easily, and an operability and convenience can be further improved.

This application is based on Japanese Patent application serial No. 2006-268910 filed in Japan Patent Office on Sep. 29, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An input display device, comprising:
a display area that displays a plurality of input keys; and
a display controller that controls display of the plurality of input keys displayed in the display area, the display controller including:
a combination data creating portion that creates combination data of a first input key and a second input key which has been selected next to the first input key, the first and second input keys selected among the plurality of input keys;
a storage portion that stores the combination data created by the combination data creating portion in a memory;
a candidate key extracting portion that extracts the second input key which has been selected next to the first input key from the memory on the basis of the combination data stored in the memory when the first input key displayed on the display area is selected; and
a display portion that allows the display area to display the second input key extracted by the candidate key extracting portion as a candidate which is to be selected next.

2. The input display device according to claim 1, further comprising:
a counter that counts the number of selections of each of a plurality of combination data created by the combination data creating portion; and
a sorting portion that stores the plurality of combination data counted by the counter into groups having the same first input key in accordance with their respective number of selections, wherein
the display controller farther includes the counter and the sorting portion, and
the candidate key extracting portion extracts from the memory the second input key included in combination data which is within a range of predetermined ranks among the combination data sorted by the sorting portion.

3. The input display device according to claim 2, wherein the display portion allows the display area to display at least one second input key extracted by the candidate key extracting portion in accordance with the rank of combination data sorted by the sorting portion.

4. The input display device according to claim 3, wherein:
the sorting portion sorts the plurality of combination data so that combination data having a large selection number comes to a higher rank, and
the display portion allows the display area to display the second input key included in the combination data sorted at the higher rank among the plurality of combination data sorted by the sorting portion as a higher-rank candidate.

5. An electronic device, comprising:
the input display device according to claim 1; and
a processing execution device that executes a predetermined processing in accordance with a selection of the plurality of input keys of the input display device.

6. An input display method comprising the steps of:
(a) creating combination data of a first input key and a second input key which has been selected next to the first input key, the first and second input keys selected among a plurality of input keys;
(b) storing the combination data created in step (a) in a memory;
(c) extracting the second input key which has been selected next to the first input key from the memory on the basis of the combination data stored in the memory when the first input key displayed on the display area is selected; and
(d) allowing the display area to display the second input key extracted in step (c) as a candidate which is to be selected next.

7. The input display method according to claim 6, further comprising:
(e) counting the number of selections of each of a plurality of combination data created in step (a); and
(f) sorting the plurality of combination data counted in step (e) into groups having the same first input key in accordance with their respective number of selections, wherein
step (c) includes a step of extracting from the memory the second input key included in combination data which is within a range of predetermined ranks among the combination data sorted in step (f).

8. The input display method according to claim 7, wherein step (d) includes a step of allowing the display area to display at least one second input key extracted in step (c) in accordance with the rank of combination data sorted in step (f).

9. The input display method according to claim 8, wherein:
step (f) includes a step of sorting the plurality of combination data so that combination data having a larger selection number comes to a higher rank, and
step (d) includes a step of displaying the second input key included in combination data sorted at the higher rank among the plurality of combination data sorted in step (f) as a higher-rank candidate.

10. A recording medium storing an input display program which allows a computer to serve as an input display device, the program allows the computer to serve as:
a combination data creating portion that creates combination data of a first input key and a second input key which has been selected next to the first input key, the first and second input keys selected among a plurality of input keys;
a storage portion that stores the combination data created by the combination data creating portion in a memory;
a candidate key extracting portion that extracts the second input key which has been selected next to the first input key from the memory on the basis of the combination data stored in the memory when the first input key displayed on the display area is selected; wherein
a display portion that allows the display area to display the second input key extracted by the candidate key extracting portion as a candidate which is to be selected next.

11. The recording medium storing the input display program according to claim 10, the program allows the computer to further serve as:
a counter that counts the number of selections of each of a plurality of combination data created by the combination data creating portion; and
a sorting portion that sorts the plurality of combination data counted by the counter into groups having the same first input key in accordance with their respective number of selections, wherein
the candidate key extracting portion extracts from the memory the second input key included in combination data which is within a range of predetermined ranks among the combination data sorted by the sorting portion.

12. The recording medium storing the input display program according to claim 11, wherein the display portion allows the display area to display at least one second input key extracted by the candidate key extracting portion in accordance with the rank of combination data sorted by the sorting portion.

13. The recording medium storing the input display program according to claim 12, wherein:
the sorting portion sorts the plurality of combination data so that combination data having a large selection number comes to a higher rank, and
the display portion allows the display area to display the second input key included in the combination data sorted at the higher rank among the plurality of combination data sorted by the sorting portion as a higher-rank candidate.
